(19) United States
(12) Patent Application Publication
(10) Pub. No.: US 2010/0188395 A1
(43) Pub. Date: Jul. 29, 2010

(54) ELECTROPHORETIC DISPLAY DEVICE DRIVING METHOD, ELECTROPHORETIC DISPLAY DEVICE, AND ELECTRONIC APPARATUS

(75) Inventors: Masami Uchida, Chino-shi (JP); Yoshiki Takei, Matsumoto-shi (JP); Atsushi Miyazaki, Suwa-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/690,996

(22) Filed: Jan. 21, 2010

(30) Foreign Application Priority Data
Jan. 26, 2009 (JP) 2009-014496

(51) Int. Cl. G09G 5/00; G09G 3/34

(52) U.S. Cl. 345/214; 345/107

(57) ABSTRACT

There is provided a method of driving an electrophoretic display device including an electrophoretic element which contains electrophoretic particles and is interposed between first and second substrates, a first electrode which is formed on the first substrate close to the electrophoretic element, and a second electrode which is formed on the second substrate close to the electrophoretic element. The method includes: detecting ambient temperature every predetermined period, and agitating the electrophoretic particles by applying a voltage to the electrophoretic element on the basis of at least one of a variation of the ambient temperature from a predetermined reference temperature and a maintenance period of the ambient temperature equal to or higher than a predetermined value.

### BACKGROUND

1. Technical Field

The present invention relates to a driving method of an electrophoretic display device, an electrophoretic display device, and an electronic apparatus.

2. Related Art

There is known an electrophoretic display device in which an electrophoretic element having charged particles and a dispersion medium is interposed between a pair of substrates. In such an electrophoretic display device, a movement speed of the charged particles depends on temperature. For this reason, in a low temperature environment, extended application of a driving voltage to the electrophoretic element for an extended time (for example, see JP-T-2007-501436) or a writing operation is repeatedly executed for every certain period to guarantee a display retention performance (for example, see JPA-2007-187936 and JP-A-2007-187938).

According to the techniques disclosed in the related art, variations in the movement speed of the charged particles can be compensated for with temperature variation. However, when the electrophoretic display device is used in a high temperature environment and then held in the high temperature environment without being operated, the charged particles may be fixed in the electrophoretic element. Therefore, burn-in may occur when the temperature returns to normal. When such burn-in occurs, an afterimage cannot be resolved even by a particle agitating operation (for example, an entire black-and-white reversion) at normal temperature.

### SUMMARY

An advantage of some aspects of the invention is that it provides a driving method of an electrophoretic display device and an electrophoretic display device capable of preventing burn-in occurring due to temperature variation.

According to an aspect of the invention, there is provided a method of driving an electrophoretic display device including an electrophoretic element which contains electrophoretic particles and is interposed between a first substrate and a second substrate, a first electrode which is disposed between the first substrate and the electrophoretic element, and a second electrode which is disposed between the second substrate and the electrophoretic element, the method comprising: detecting ambient temperature every predetermined period, and agitating the electrophoretic particles by applying a voltage to the electrophoretic element on the basis of at least one of a variation of the ambient temperature from a predetermined reference temperature and a maintenance period of the ambient temperature equal to or higher than a predetermined value.

According to the driving method, the variation of the ambient temperature or the maintenance period under the predetermined environment are detected. When a preset condition is satisfied, the electrophoretic particles are agitated. In this way, when the electrophoretic display device is used in the environment where burn-in may occur, it is possible to prevent the electrophoretic particles from being fixed within the device. Accordingly, since it is possible to prevent burn-in that may occur due to the variation in the ambient temperature, a display quality can be maintained for a long time.

In the method according to the aspect of the invention, the agitating of the electrophoretic particles may be executed when the ambient temperature is increased by 35° C. or more from the reference temperature.

According to the examination of the inventors, when the device is used at a temperature higher than a temperature of a normal use condition by 35° C., the burn-in may occur. Accordingly, by executing the agitating of the electrophoretic particles when the variation of the ambient temperature is 35° C. or more, it is possible to prevent the burn-in from occurring.

The burn-in gradually occurs with an increase in the ambient temperature from the reference temperature. Accordingly, by executing the agitation of the electrophoretic particles before the variation of the ambient temperature reaches 35° C., the display quality can be maintained satisfactorily. However, since the frequent agitating of the electrophoretic particles is disadvantageous in terms of power consumption, optimization between power consumption and display quality is required. Moreover, since it takes long time for the burn-in to occur when the variation of the ambient temperature is lower than 35° C., an effect of preventing the burn-in can be obtained by the agitation of the electrophoretic particles by the display rewriting. Therefore, the burn-in rarely occurs in effect. Accordingly, it is desirable that the temperature of 35° C. is set to the reference value.

In terms of less power consumption, it is effective to agitate the electrophoretic particles when the variation of the ambient temperature is greatly higher than 35° C. However, it is necessary to examine a balance with the requested display quality.

In the method according to the aspect of the invention, a degree of agitation of the electrophoretic particles may depend on the variation in the agitating of the electrophoretic particles.

According to the examination of the inventors, the degree of the burn-in changes depending on the high temperature. By changing the degree of agitation of the electrophoretic particles in accordance with the variation of the ambient temperature in the agitating of the electrophoretic particles, it is possible to reliably prevent the burn-in from occurring independently of the temperature under high-temperature condition.

In the method according to the aspect of the invention, the agitating of the electrophoretic particles may be executed when the maintenance period is 10 hours or more at the ambient temperature higher than the reference temperature.

According to the examination of the inventors, the burn-in occurs considerably when the device is held for 70 hours at high temperature. For example, when the device is held at 60° C. for about 20 hours or the device is held at 85° C. for about 10 hours, reflectance is reduced by about 2%, which is a level at which the burn-in can be recognized, from the initial reflectance.

By setting the shortest period, i.e. 10 hours, as the maintenance period until the agitating of the electrophoretic particles, it is possible to prevent the burn-in from occurring. Of course, when the electrophoretic particles are agitated after a shorter period, it is advantageous for keeping good display quality. However, since the frequent agitating of the electrophoretic particles is disadvantageous in terms of power consumption, optimization between power consumption and display quality is required. The maintenance period of 10 hours is set in this viewpoint. When the electrophoretic particles are agitated long after the maintenance period of 10 hours, the power consumption is small, but the burn-in easily occurs. Therefore, this maintenance period may be set in terms of a balance with the requested display quality.

In the method according to the aspect of the invention, a degree of agitation of the electrophoretic particles may depends on the maintenance period in the agitating of the electrophoretic particles.

According to the examination of the inventors, the degree of the burn-in depends on the maintenance period at the high temperature. By changing the degree of agitation of the electrophoretic particles in the agitating of the electrophoretic particles in accordance with the maintenance period at the ambient temperature, it is possible to prevent the burn-in without dependence on the length of the maintenance period.

In the method according to the aspect of the invention, the reference temperature may be an average value of the ambient temperatures during a predetermined period.

In such a driving method, the ambient temperature at which the electrophoretic display device is usually used can be reflected in determining the execution of the burn-in preventing operation. Accordingly, the burn-in preventing operation can appropriately be executed without dependence on the use environment.

According to another aspect of the invention, there is provided a method of driving an electrophoretic display device including an electrophoretic element which contains electrophoretic particles and is interposed between a first substrate and a second substrate, a first electrode which is disposed between the first substrate and the electrophoretic element, and a second electrode which is disposed between the second substrate and the electrophoretic element, the method comprising: detecting ambient temperature every predetermined period, and agitating the electrophoretic particles by applying a voltage to the electrophoretic element when the ambient temperature is 60° C. or more.

According to this driving method, the ambient temperature is detected. When the ambient temperature is a temperature equal to or higher than the preset reference temperature, the electrophoretic particles are agitated. Accordingly, when the electrophoretic display device is used under the environment where the burn-in may occur, it is possible to prevent the electrophoretic particles from being fixed within the electrophoretic display device. Moreover, since the execution of the burn-in preventing operation is simply determined, this driving method is advantageous in terms of the power consumption and the manufacturing cost.

In the method according to the aspect of the invention, a degree of agitation of the electrophoretic particles may be set on the basis of a current ambient temperature in the agitating of the electrophoretic particles.

According to this driving method, since the electrophoretic particles can be agitated with an appropriate intensity in accordance with the ambient temperature, it is possible to more reliably prevent the burn-in from occurring.

In the method according to the aspect of the invention, a degree of agitation of the electrophoretic particles may be adjusted by varying a voltage which is applied to the electrophoretic element in the agitating of the electrophoretic particles. Alternatively, in the agitating of the electrophoretic particles, a degree of agitation of the electrophoretic particles may be adjusted by varying at least one of the pulse width and the pulse number of a voltage pulse which is supplied to the electrophoretic element.

That is, the degree of agitation of the electrophoretic particles in the agitating of the electrophoretic particles can be adjusted in accordance with the voltage applied to the electrophoretic element or the application time.

In the method according to the aspect of the invention, the agitating of the electrophoretic particles may be repeatedly executed every predetermined period in the agitating of the electrophoretic particles.

In this driving method, since the agitating of the electrophoretic particles is executed for a relatively long time, it is possible to prevent the burn-in even when the interval of the temperature detection is made long.

In the method according to the aspect of the invention, a degree of agitation of the electrophoretic particles may be adjusted by varying the interval at which the agitating is executed, in the agitating of the electrophoretic particles. The degree of agitation of the electrophoretic particles may be adjusted at the interval at which the agitating is executed.

According to still another aspect of the invention, there is provided an electrophoretic display device including: an electrophoretic element which contains electrophoretic particles and is interposed between a first substrate and a second substrate; a first electrode which is disposed between the first substrate and the electrophoretic element; a second electrode which is disposed between the second substrate and the electrophoretic element; a temperature detector which detects ambient temperature; and a control unit connected to the temperature detector, the control unit detecting the ambient temperature every predetermined period by means of the temperature detector and executing agitation of the electrophoretic particles by applying a voltage to the electrophoretic element, by means of the first electrode and the second electrode, on the basis of at least one of a variation of the ambient temperature from a predetermined reference temperature and a maintenance period of the ambient temperature equal to or higher than a predetermined value.

With such a configuration, when the variation of the ambient temperature and the maintenance period are detected under the predetermined environment and the preset condition is satisfied, the electrophoretic particles are agitated. In this way, when the electrophoretic display device is used in the environment where burn-in may occur, it is possible to prevent the electrophoretic particles from being fixed within the device. Accordingly, since it is possible to prevent the burn-in caused due to the variation in the ambient temperature, the display quality can be maintained for a long time.

In the electrophoretic display device according to the aspect of the invention, the control unit may execute the agitation of the electrophoretic particles when the ambient temperature is 60° C. or more.

With such a configuration, when the ambient temperature is detected and the ambient temperature is the temperature equal to or higher than the preset reference temperature, the electrophoretic particles are agitated. In this way, when the electrophoretic display device is used in the environment where burn-in may occur, it is possible to prevent the electrophoretic particles from being fixed within the device. Moreover, since the execution of the burn-in preventing operation is simply determined, this configuration is advantageous in terms of power consumption and manufacturing cost.

According to still another aspect of the invention, there is provided an electronic apparatus comprising the electrophoretic display device described above.

When the electronic apparatus is used at the high temperature, similar burn-in can be prevented. Therefore, it is possible to provide the electronic apparatus including the display device capable of keeping good display quality for a long time.

### BRIEF DESCRIPTION OF THE DRAWINGS

The invention will be described with reference to the accompanying drawings, wherein like numbers reference like elements.

FIG. 1 is a schematic diagram illustrating the configuration of an electrophoretic display device according to an embodiment.

FIGS. 2A and 2B are diagrams illustrating the sectional configuration and the electric configuration of the electrophoretic display device.

FIGS. 3A and 3B are explanatory diagrams illustrating an operation of an electrophoretic element.

FIG. 4 is a block diagram illustrating functions of the electrophoretic display device.

FIG. 5 is a graph illustrating an experimental result of burn-in.

FIG. 6 is a graph illustrating an experimental result of burn-in.

FIG. 7 is a flowchart illustrating a first driving method.

FIGS. 8A to 8D are diagrams illustrating potential states of each electrode in a particle agitating step.

FIG. 9 is a flowchart illustrating a second driving method.

FIG. 10 is a flowchart illustrating a third driving method.

FIG. 11 is a flowchart illustrating a fourth driving method.

FIG. 12 is a diagram illustrating an example of an electronic apparatus.

FIG. 13 is a diagram illustrating an example of the electronic apparatus.

FIG. 14 is a diagram illustrating an example of the electronic apparatus.

### DESCRIPTION OF EXEMPLARY EMBODIMENTS

Hereinafter, an electrophoretic display device and a driving method of the same according to the invention will be described with reference to the drawings.

The embodiment is just an exemplary example of the invention. The invention is not limited to this embodiment but may be modified in various forms within the technical scope of the invention. In order to enable easy description of elements in the accompanying drawings, the elements are appropriately shown with different scales and in different numbers.

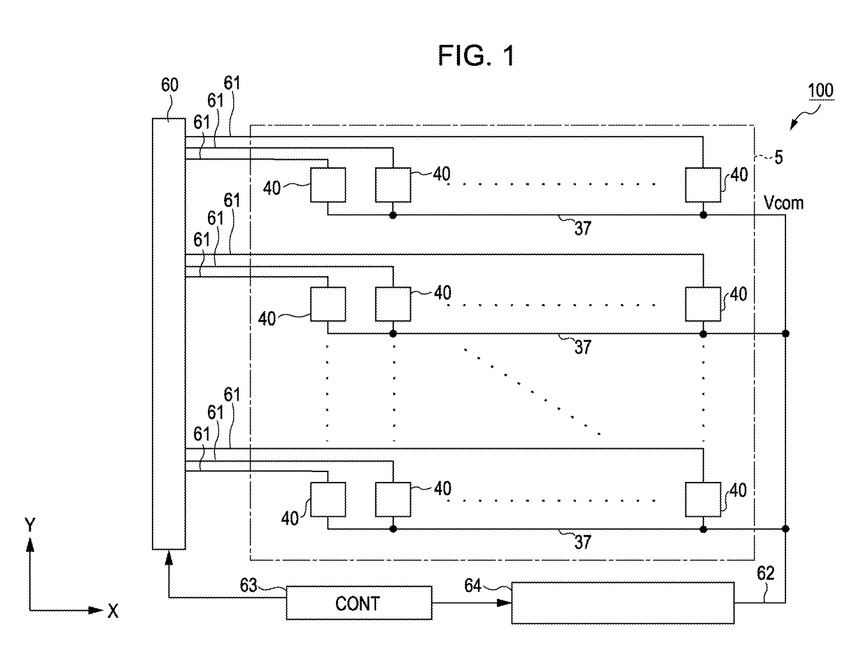

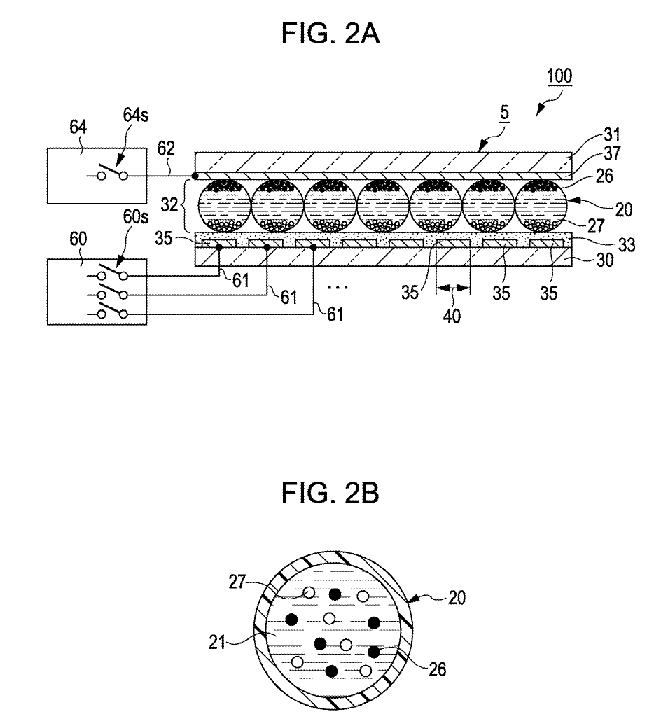

FIG. 1 is a schematic diagram illustrating the configuration of an electrophoretic display device 100 according to an embodiment of the invention. FIG. 2A is a diagram illustrating the sectional configuration and the electric configuration of the electrophoretic display device 100.

The electrophoretic display device 100 includes a display unit 5 in which a plurality of pixels (segments) 40 is arranged, a controller (control unit) 63, and a pixel electrode driving circuit 60 connected to the controller 63. The pixel electrode driving circuit 60 is connected to pixels 40 via pixel electrode wires 61. In the display unit 5, a common electrode 37 (see FIGS. 2A and 2B) common to the pixels 40 is disposed. In FIG. 1, the common electrode 37 is simply illustrated by a wire.

The electrophoretic display device 100 is a segment driving type electrophoretic display device which transmits image data from the controller 63 to the pixel electrode driving circuit 60 and directly inputs potential based on the image data to the respective pixels 40.

As shown in FIG. 2A, the display unit 5 of the electrophoretic display device 100 has a configuration in which an electrophoretic element 32 is interposed between a first substrate 30 and a second substrate 31. A plurality of pixel electrodes (segment electrode: first electrode) 35 is formed on the first substrate 30 close to the electrophoretic element 32 and the common electrode (second electrode) 37 is formed on the second substrate 31 close to the electrophoretic element 32. In the electrophoretic element 32, a plurality of microcapsules 20 enclosing electrophoretic particles therein is arranged in a planar shape. The electrophoretic display device 100 displays an image formed by the electrophoretic element 32 on the side of the common electrode 37.

The first substrate 30 is a substrate made of glass, plastic, or the like. The first substrate 30 may not be transparent since the first substrate 30 is disposed on a side opposite to an image display surface. The pixel electrodes 35 is formed by sequentially laminating a nickel plate and a gold plate on a Cu (copper) foil or formed of Al (aluminum), ITO (Indium Tin Oxide), or the like.

On the other hand, the second substrate 31 is a substrate made of glass, plastic, or the like. The second substrate 31 is transparent since the second substrate 31 is disposed on the side of the image display surface. The common electrode 37 is a transparent electrode formed of MgAg (magnesium sliver), ITO, IZO (registered trademark: Indium Zinc Oxide), or the like.

The pixel electrode driving circuit 60 is connected to the pixel electrodes 35 via the pixel electrode wires 61. Since switching elements 60s respectively connected to the pixel electrode wires 61 are installed in the pixel electrode driving circuit 60, the switching elements 60s are operated to input potential to the pixel electrodes 35 and to interrupt the inputting (high impedance) to the pixel electrodes 35.

On the other hand, a common electrode driving circuit 64 is connected to the common electrode 37 via a common electrode wire 62. Since a switching element 64s connected to the common electrode wire 62 is installed in the common pixel electrode driving circuit 64, the switching element 64s is operated to input potential to the common electrode 37 and to interrupt the inputting (high impedance) to the common electrode 37.

The electrophoretic elements 32 are formed in advance on the second substrate 31 and are generally treated as an electrophoretic sheet including the adhesive layer 33. In the manufacturing process, the electrophoretic sheet is treated in a state where a protective release sheet is bonded to the surface of the adhesive layer 33. The electrophoretic sheet from which the protective peeling sheet is removed is bonded to the first substrate 30 (on which the pixel electrodes 35 and the like are formed) manufactured independently to form the display unit 5. Accordingly, the adhesive layer 33 exists on only the side close to the pixel electrodes 35.

FIG. 2B is a schematic sectional view illustrating the microcapsule 20. The microcapsule 20 has a particle diameter from about 30 μm to about 50 μm, for example, and a spherical member in which a dispersion medium 21, plural white particles (electrophoretic particles) 27, and plural black particles (electrophoretic particles) 26 are enclosed. As shown in FIGS. 2A and 2B, the microcapsules 20 is interposed between the common electrode 37 and the pixel electrodes 35 and one or plural microcapsules 20 are disposed in one pixel 40.

The outer shell (wall membrane) of the microcapsule 20 is formed of transparent polymer resin such as acryl resin such as polymethyl methacrylate and polyethyl methacrylate, urea resin, and gum Arabic.

The dispersion medium 21 is a liquid for dispersing the white particles 27 and the black particles 26 in the microcapsule 20. Examples of the dispersion medium 21 include water, alcoholic solvent (such as methanol, ethanol, isopropanol, butanol, octanol, and methyl cellosolve), esters (such as ethyl acetate and butyl acetate), ketones (such as acetone, methylethyl ketone, and methyl isobutyl ketone), aliphatic hydrocarbons (such as pentane, hexane, and octane), alicyclic hydrocarbons (such as cyclohexane and methyl cyclohexane), aromatic hydrocarbons (such as benzene, toluene, and benzenes having a long-chain alkyl group (such as xylene, hexyl benzene, heptyl benzene, octyl benzene, nonyl benzene, decyl benzene, undecyl benzene, dodecyl benzene, tridecyl benzene, and tetradecyl benzene)), halogenated hydrocarbon (such as methylene chloride, chloroform, carbon tetrachloride, and 1,2-dichloroethane), carboxylate salt, and other oil substances. These materials may be used singly or as a mixture and may be mixed with surfactant and the like.

The white particles 27 are particles (polymer or colloid) formed of white pigments such as titanium dioxide, zinc flower, and antimony trioxide and are charged to, for example, negative polarity for use. The black particles 26 are particles (polymer or colloid) formed of black pigments such as aniline black and carbon black and are charged to, for example, positive polarity for use.

A charging control agent including particles of electrolyte, surfactant, metal soap, resin, rubber, oil, varnish, or compound, a dispersion solvent such as titanium coupling agent, aluminum coupling agent, and silane coupling agent, lubricant, and stabilizer may be added to the pigments as needed.

For example, red, green, and blue pigments may be used instead of the black particles 26 and the white particles 27. In this case, the display unit 5 can display red, green, and blue.

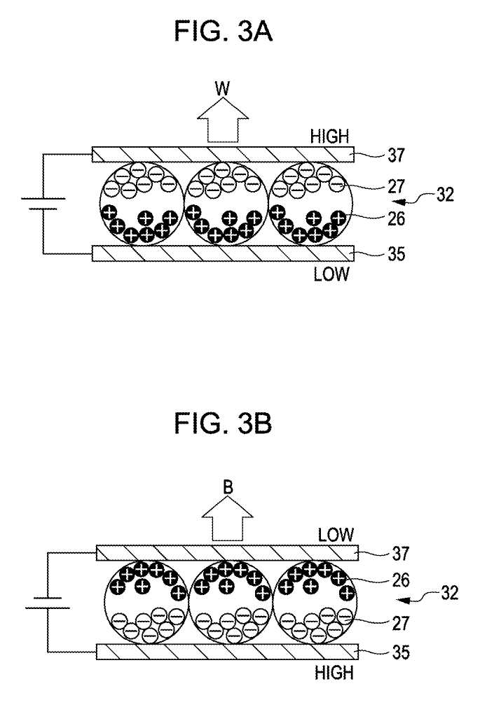

FIGS. 3A and 3B are explanatory diagrams illustrating an operation of an electrophoretic element. FIG. 3A shows a state where the pixel 40 displays white and FIG. 3B shows a state where the pixel 40 displays black.

In the white display shown in FIG. 3A, the common electrode 37 has a relatively high potential and the pixel electrode 35 has a relatively low potential. Accordingly, the white particles 27 negatively charged are attracted to the common electrode 37 and the black particles 26 positively charged are attracted to the pixel electrode 35. As a result, when the pixel is viewed from the common electrode 37 serving as the display surface, white (W) is recognized.

In the black display shown in FIG. 3B, the common electrode 37 is in the relatively low potential and the pixel electrode 35 is in the relatively high potential. Accordingly, the black particles 26 positively charged are attracted to the common electrode 37 and the white particles 27 negatively charged are attracted to the pixel electrode 35. As a result, when the pixel is viewed from the common electrode 37, black (B) is recognized.

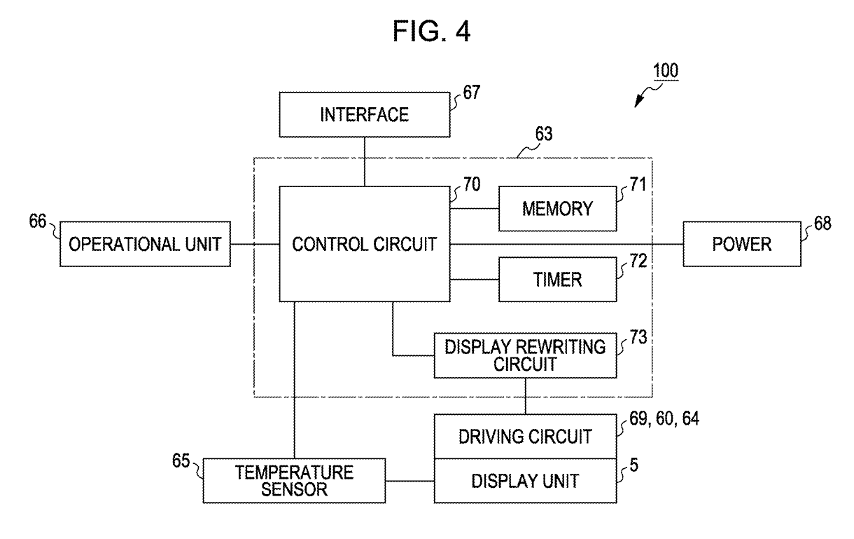

FIG. 4 is a block diagram illustrating functions of the electrophoretic display device 100.

The electrophoretic display device 100 includes a controller 63, a temperature sensor 65, an operational unit 66, an interface 67, a power 68, and a driving circuit 69, as shown in FIG. 4. The driving circuit 69 includes the pixel electrode driving circuit 60 and the common electrode driving circuit 64 shown in FIG. 1 and FIGS. 2A and 2B and is connected to the display unit 5.

The controller 63 includes a control circuit 70, a memory 71 (memory unit), a timer 72, and a display rewriting circuit 73.

The control circuit 70 serves as a CPU (Central Processing Unit) of the electrophoretic display device 100 and controls a variety of operations of each unit of the electrophoretic display device 100. The control circuit 70 is connected to the memory 71, the timer 72, and the display rewriting circuit 73 within the controller 63. The control circuit 70 is also connected to the temperature sensor 65 (temperature detector), the operational unit 66, the interface 67, and the power 68 which are installed outside the controller 63.

The memory 71 may be a volatile memory or a non-volatile memory. An SRAM (Static Random Access Memory) or a DRAM (Dynamic Random Access Memory), for example, may be used as the volatile memory. A mask ROM (Read-Only Memory), a flash memory, or a FeRAM (Ferroelectric Random Access Memory), for example, may be used as the non-volatile memory.

The memory 71 stores predetermined image data in which a display image pattern or the like is determined at power-ON time or power-OFF time, a LUT (Look-Up Table) defining a correspondent relationship between temperature information and operational modes, a program for controlling and driving the display unit 5, and the like. The memory 71 also serves as a working memory for maintaining temperature information acquired by the temperature sensor 65, operation time information, or the like.

The timer 72 measures desired time independently or under the control of the control circuit 70. The configuration of the timer 72 is not particularly limited. The timer 72 may be included in the controller 63 or may be mounted independently like the temperature sensor 65.

The display rewriting circuit 73 converts image data, which is input to the control circuit 70 via the interface 67 and is transmitted from the control circuit 70, into image data which can be displayed by the pixels 40 of the display unit 5. The image data converted by the display rewriting circuit 73 contains display color information corresponding to the respective pixels 40. The image data generated by the display rewriting circuit 73 is transmitted to the driving circuit 69 (the pixel electrode driving circuit 60 and the common electrode driving circuit 64).

The temperature sensor 65 is a sensor of which an electric value such as a resistant value or a capacitance value is changed in response to temperature. The temperature sensor 65 transmits a detected temperature to the control circuit 70. For example, a thermistor or a thermocouple can be used as the temperature sensor 65. Since a signal input from the temperature sensor 65 to the control circuit 70 is an analog signal, it is desirable that the controller 63 or the control circuit 70 has an AD converter capable of executing AD conversion from the detected analog signal to data serving as encoded temperature information.

One temperature sensor or plural temperature sensors 65 may be included in the electrophoretic display device 100 and installed at regions where the temperature of the display unit 5 shown FIG. 1 and FIGS. 2A and 2B can be measured.

For example, the temperature sensor 65 may be attached the back surface of the first substrate 30 shown in FIG. 2A. When the planar area of the display unit 5 is large, the temperature sensor 65 may be disposed at a region near the center of the display unit 5 and two regions of the periphery of the display unit 5. When the plural temperature sensors 65 are disposed, a simple average value, a weighted average value, or the maximum value of the plural temperatures measured by the plural temperature sensors 65 may be used as the temperature information obtained by the control circuit 70.

The operational unit 66 is a user interface of the electrophoretic display device 100 through which a user inputs an operation instruction.

The interface 67 is a connection unit of the electrophoretic display device 100 connected to an external apparatus (not shown). The interface 67 transmits image data or a command input from the external apparatus to the control circuit 70 and transmits a response signal or the like output from the control circuit 70.

The power 68 is a battery supplying power to the electrophoretic display device 100 or a power circuit connected to an external power source.

The driving circuit 69 inputs image signals to the pixels 40 on the basis of the image data input from the display rewriting circuit 73. The electrophoretic element 32 of the pixels 40 is driven by the image signals to display an image defined by the image data on the display unit 5.

### Driving Methods

Next, a method of driving the electrophoretic display device having the above-described configuration will be described.

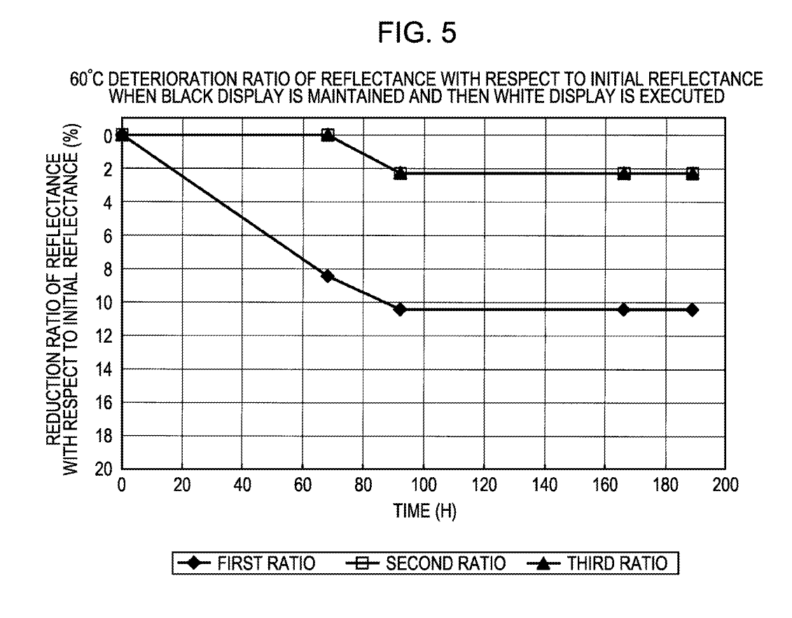

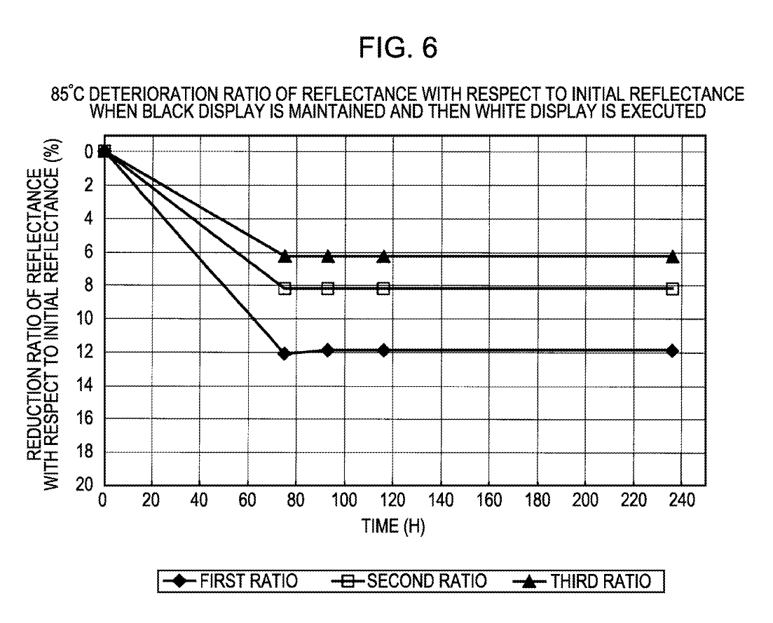

FIGS. 5 and 6 are graphs illustrating experimental results of burn-in when the electrophoretic display device 100 is held at high temperature. The experiment for measuring reflectance was carried out such that the electrophoretic display device 100 maintains a non-operation state (entire black display) at 60° C. or 85° C. for a predetermined period, and then the temperature is returned to the normal temperature (25° C.) to execute an entire white display operation. In FIG. 5, the temperature is maintained at 60° C. In FIG. 6, the temperature is maintained at 85° C. The vertical axis in FIGS. 5 and 6 represents a reduction ratio of the reflectance against an initial reflectance (reflectance before maintenance of high temperature). For example, 2% in the vertical axis means that the reflectance is 0.98 when the initial reflectance is 1.

A “first ratio” in each graph is a ratio of the reflectance when the high temperature is maintained and then the display unit 5 having executing the black display executes the entire white display. A “second ratio” is a ratio of the reflectance when the entire black display is executed and then the entire white display is executed after the entire white display in the “first ratio”. A “third ratio” is a ratio of the reflectance when the entire black display is executed and then the entire white display is again executed after the entire white display in the “second ratio”.

Either in the case of maintaining at 60° C. or at 85° C., as show in FIGS. 5 and 6, reduction in the reflectance was observed in “first writing” under the condition of all maintenance periods. In particular, when the maintenance period exceeds 70 hours, the reflectance is not returned even after “second writing”, thereby causing burn-in.

Either in the case of maintaining at 60° C. or at 85° C., as the maintenance period is longer, the reduction in the reflectance becomes increased. Therefore, a recovery degree of the reflectance upon repeating the writing shows a tendency to decrease.

When the condition of maintaining at 60° C. is compared to the condition of maintaining at 85° C., the reduction in the reflectance after the maintenance of the high temperature is considerable under the condition of maintaining at 85° C. Moreover, even when the writing is executed several times, the recovery degree of the reflectance is low.

First to fourth driving methods described below are based on the above-described experimental results and are a driving method capable of preventing the burn-in.

### First Driving Method

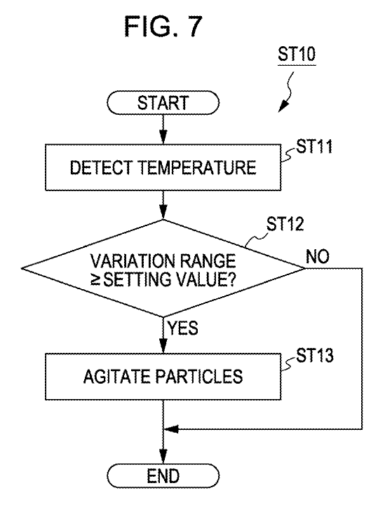

FIG. 7 is a flowchart illustrating the first driving method of driving the electrophoretic display device.

According to the experimental results shown in FIGS. 5 and 6, desired reflectance cannot be obtained at first image writing, when the high temperature of at least 60° C. is maintained and then returned to the normal temperature (25° C.). Here, in the first driving method, the variation of the ambient temperature of the electrophoretic display device 100 is considered. A burn-in preventing operation is executed when the variation of the ambient temperature is equal to or larger than a setting value.

As shown in FIG. 7, the first driving method includes a burn-in preventing step ST10 which includes a temperature detecting step ST11, a variation determining step ST12, and a particle agitating step ST13.

First, in the temperature detecting step ST11, the control circuit 70 acquires the temperature information from the temperature sensor 65, maintains the temperature information as a current ambient temperature (the temperature of the display unit 5), and stores the temperature information in an ambient temperature memory area (not shown) of the memory 71. Subsequently, the process proceeds to the variation determining step ST12.

When the process proceeds to the variation determining step ST12, the control circuit 70 first reads a reference temperature and the setting value of the variation stored in the memory 71.

For example, the reference temperature stored in the memory 71 is general ambient temperature (normal temperature) from about 20° C. to about 25° C. or temperature of supposed use environment. When the reference temperature is set in this way, the reference temperature is preferably stored in advance in the memory 71.

The reference temperature may be determined as the average value of the ambient temperature values detected for a certain period by the temperature sensor 65. In this case, the plurality of temperature information acquired in the temperature detecting step ST11 may be stored in the memory 71 by the predetermined number of times or for a predetermined period, the average value is calculated from the temperature information in the control circuit 70, this average value may be used as the reference temperature.

In this embodiment, the setting value of the variation stored in the memory 71 is set to 35° C. This setting value may be changed in accordance with the characteristics of the electrophoretic element 32 (electrophoretic sheet) used. For example, in the electrophoretic element 32 in which the burn-in rarely occurs due to temperature variation, the setting value of the variation may be set to be larger than 35° C. On the contrary, in the electrophoretic element 32 in which the burn-in easily occurs, it is preferable that the setting value of the variation is set to be smaller than 35° C.

Next, the control circuit 70 calculates a temperature difference (variation) between the current ambient temperature and the reference temperature. Subsequently, the calculated variation is compared to the setting value of the variation read from the memory 71. When the calculated variation is equal to or larger than the setting value, the process proceeds to the particle agitating step ST13. Alternatively, if the calculated variation is smaller than the setting value, the burn-in preventing step ST10 is terminated (end).

The determination operation will be described more specifically. On the assumption that the reference temperature 25° C. and the setting value of the variation is 35° C., the particle agitating step ST13 is executed when the ambient temperature is equal to or higher than 60° C. Alternatively, the burn-in preventing step ST10 is terminated when the ambient temperature is smaller than 60° C.

When the particle agitating step ST13 is executed, the control circuit 70 drives the display rewriting circuit 73 to agitate the electrophoretic particles (the black particles 26 and the white particles 27) of the electrophoretic element 32.

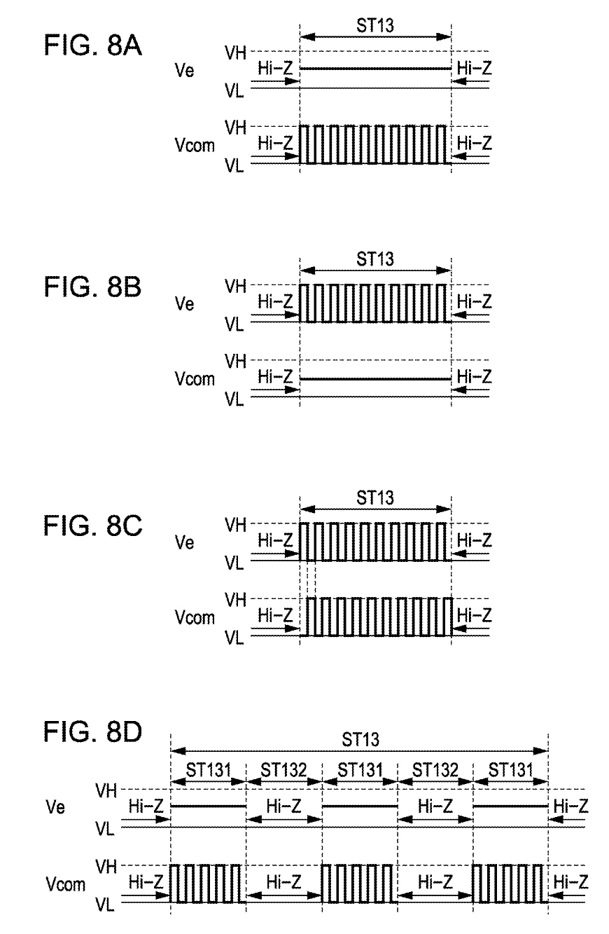

FIGS. 8A to 8D are diagrams illustrating potential states of the pixel electrodes 35 and the common electrode 37 in the particle agitating step ST13. FIGS. 8A and 8D each show a potential Ve of the pixel electrodes 35 and a potential Vcom of the common electrode 37 with time elapsed.

In the particle agitating step ST13, as shown in FIG. 8A, for example, a mid potential (VH+VL)/2 (for example, 7.5 V) between a high-level potential VH (for example, 15 V) and a low-level potential VL (for example, 0 V) is input to all of the pixel electrodes 35 of the display unit 5. On the other hand, a rectangular wave pulse, in which the high-level potential VH (for example, 15 V) and the low-level potential VL (for example, 0 V) are periodically repeated, is input to the common electrode 37.

While the common electrode 37 is in the high-level potential VH, the potential of the common electrode 37 is higher than that of the pixel electrodes 35 and thus the electrophoretic element 32 displays white (see FIG. 3A). On the contrary, while the common electrode 37 is in the low-level potential VL, the potential of the common electrode 37 is lower than that of the pixel electrodes 35 and thus the electrophoretic element 32 displays black (see FIG. 3B). That is, the entire white display and the entire black display are alternately executed by the display unit 5, so that the electrophoretic particles of the electrophoretic element 32 are agitated in the microcapsules 20.

By agitating the electrophoretic particles, it is possible to prevent the electrophoretic particles from being fixed to the wall films of the microcapsules 20. Accordingly, when the temperature is lowered to the normal temperature, it is possible to prevent the burn-in form occurring.

The method of agitating the electrophoretic particles in the particle agitating step ST13 is not limited to the method shown in FIG. 8A. However, an arbitrary driving method may be used as long as the electrophoretic particles in the electrophoretic element 32 are agitated.

For example, as shown in FIG. 8B, the potential Vcom of the common electrode 37 may be set to a certain mid potential and a pulse, in which the high-level potential VH and the low-level potential VL are periodically repeated, may be input to the pixel electrodes 35.

Alternatively, as shown in FIG. 8C, a pulse, in which the high-level potential VH and the low-level potential VL are periodically repeated, may be input to the pixel electrodes 35 and a pulse with an opposite phase of the pulse input to the pixel electrodes 35 may be input to the common electrode 37. In this case, since a voltage corresponding to a potential difference between the high-level potential VH and the low-level potential VL can be applied to the electrophoretic element 32, the operation of agitating the electrophoretic particles becomes more effective, compared with the cases shown in FIGS. 8A and 8B.

As shown in FIG. 8D, an agitating step ST131 of agitating the electrophoretic particles by applying a voltage to the electrophoretic element 32 and a wait step ST132 of applying no voltage to the electrophoretic element 32 may be executed several times during the particle agitating step ST13.

When the wait step ST132 is executed and the agitating step ST131 is executed for every predetermined period, the particle agitating step ST13 is executed during a relatively long period. Accordingly, it is possible to prevent the burn-in even when an interval of the temperature detection becomes longer.

The above-described burn-in preventing step ST10 is executed for every predetermined period on the basis of the measurement result of the timer 72 installed in the controller 63 of the electrophoretic display device 100.

For example, when the timer 72 operates independently of the control circuit 70, the timer 72 outputs an interrupt signal to the control circuit 70 on the basis of the measurement result and the control circuit 70 receiving the interrupt signal executes the burn-in preventing step ST10.

On the contrary, when the timer 72 is controlled by the control circuit 70, the control circuit 70 outputs a measurement start signal (count start signal) to the timer 72 and receives a measurement end signal (count end signal) returned from the timer 72 to execute the burn-in preventing step ST10.

The burn-in preventing step ST10 is treated in principle as an operation independent from the other operations (an image display operation, etc.) of the electrophoretic display device 100. That is, the burn-in preventing step is executed even though the electrophoretic display device 100 is in an image display operation, in an image maintenance operation, in a normal operation or in a standby operation.

However, the relation with the other operations is not limited to the above description, but may appropriately be adjusted. For example, during the image display operation of the electrophoretic display device 100, the burn-in preventing step may be delayed until the end of the image display operation. Alternatively, only while the electrophoretic display device 100 is in the image maintenance operation or in the standby operation, the burn-in preventing step ST10 may be executed.

When the burn-in preventing step ST10 is executed during the image display operation or immediately after the image display operation, a displayed image disappears due to the particle agitating operation. Therefore, the image display operation is again executed after the burn-in preventing step ST10 ends.

### Second Driving Method

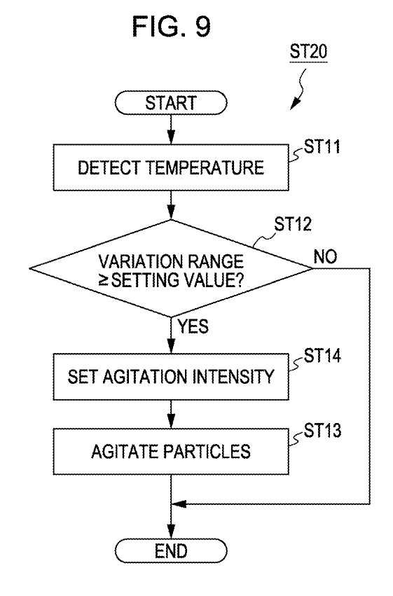

FIG. 9 is a flowchart illustrating a second driving method according to this embodiment.

As described above with reference to FIGS. 5 and 6, the degree of the burn-in occurring when the electrophoretic display device is maintained at the high temperature depends on the temperature condition of the high temperature. In the second driving method, a degree of agitation of the electrophoretic particles in the particle agitating step ST13 may be made different depending on the ambient temperature, in addition to the configuration of the above-described first driving method.

As shown in FIG. 9, the second driving method according to this embodiment includes a burn-in preventing step ST20 including the temperature detecting step ST11, the variation determining step ST12, an agitation intensity setting step ST14, and the particle agitating step ST13.

In the agitation intensity setting step ST14, an agitation intensity of the electrophoretic particles in the particle agitating step ST13 is set.

More specifically, in the control circuit 70, a calculation operation using the temperature information (ambient temperature) acquired in the temperature detecting step ST11 or a table reference is executed. Then, operation parameters in the particle agitating step ST13 are set on the basis of the execution result.

The set operation parameters include the potential (amplitude) or the pulse width of a pulse input to the pixel electrodes 35 (and the common electrode 37), the length of a voltage application period, and the length of a wait period in the particle agitating step ST13.

An expression used in the calculation operation is an expression which relates the ambient temperature to one or a plurality of the above operation parameters. The table to be referred is a table which relates the ambient temperature to one or a plurality of the above operation parameters.

For example, when the driving pulses shown in FIGS. 8A to 8C are used in the particle agitating step ST13, an expression or a table, which relates the ambient temperature to one or a plurality of the pulse amplitude, the pulse width, and the voltage application period (the length of the particle agitating step ST13), can be used as the calculation expression or the table.

In the experimental examples shown in FIGS. 5 and 6, as the temperature of the high temperature environment is higher, the burn-in degree becomes larger. Accordingly, in the calculation expression or the table, the pulse amplitude, the pulse width, and the voltage application period can be related to the ambient temperature so that the pulse amplitude, the pulse width, and the voltage application period become larger as the ambient temperature is higher. That is, the calculation expression or the table is made such that the degree of agitation of the electrophoretic particles become larger as the ambient temperature is higher.

In the agitation intensity setting step ST14, one or a plurality of the pulse amplitude, the pulse width, and the voltage application period is calculated or obtained as the operation parameters in the particle agitating step ST13 by the calculation operation or the table reference using the temperature information obtained in the temperature detecting step ST11.

For example, when the driving pulse shown in FIG. 8D is used in the particle agitating step ST13, a calculation expression or a table, which relates the ambient temperature to one or both of the voltage application period (the length of the agitating step ST131) and the wait period (the length of the wait step ST132), can be used as the calculation expression or the table. Specifically, in the calculation expression or the table, the ambient temperature can be related to the operation parameters such that the voltage application period becomes longer and the wait period becomes shorter as the ambient temperature is higher.

In the agitation intensity setting step ST14, one or both of the voltage application period and the wait period is calculated or acquired as the operation parameters in the particle agitating step ST13 by the calculation operation or the table reference using the temperature information acquired in the temperature detecting step ST11.

When the operation parameters are set, the particle agitating step ST13 is executed.

In the particle agitating step ST13, the pulse shown in each of FIGS. 8A to 8D is input on the basis of the operation parameters set in the agitation intensity setting step ST14. In this way, an appropriate particle agitation operation is executed in accordance with the ambient temperature.

According to the second driving method, by executing the burn-in preventing step ST20, it is possible to reliably prevent the burn-in without dependence on the ambient condition.

The burn-in preventing step ST20 of the second driving method can also be executed independently of the image display operation, like the burn-in preventing step ST10 of the first driving method.

### Third Driving Method

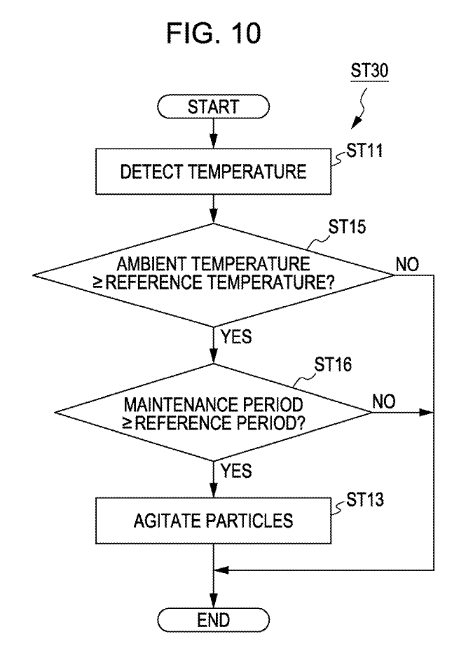

FIG. 10 is a flowchart illustrating a third driving method of driving the electrophoretic display device.

According to the experimental results shown in FIGS. 5 and 6, the degree of the burn-in becomes larger as the maintenance period of the high temperature is longer under either the 60° C. maintenance condition or 85° C. maintenance condition. Here, in the third driving method, the maintenance period of the high temperature environment of the electrophoretic display device 100 is considered. The burn-in preventing operation is executed when the maintenance period is equal to or longer than a setting value.

As shown in FIG. 10, the third driving method includes a burn-in preventing step ST30 including the temperature detecting step ST11, an ambient temperature determining step ST15, a maintenance period determining step ST16, and the particle agitating step ST13.

In the ambient temperature determining step ST15, the reference temperature stored in the memory 71 is first read by the control circuit 70. Unlike the first driving method, the reference temperature stored in the memory 71 is an ambient temperature at which the burn-in may occur when the maintenance period is long. Accordingly, the reference temperature is set to a value in the range from 45° C. to 85° C., for example. As described below, the ambient temperature may be set to a value in the range from 20° C. to 25° C. like the first embodiment, when it is necessary to prevent the burn-in more reliably.

Next, the control circuit 70 compares the current ambient temperature to the reference temperature. When the ambient temperature is equal to or higher than the reference temperature, the process proceeds to the maintenance period determining step ST16. Alternatively, when the ambient temperature is lower than the reference temperature, the burn-in preventing step ST30 is terminated (end).

In the maintenance period determining step ST16, it is determined whether a period during which the ambient temperature equal to or higher than the reference temperature is maintained is equal to or higher than a predetermined reference period. Specifically, in the maintenance period determining step ST16, the period (maintenance period) during which the ambient temperature is equal to or higher than the reference temperature is calculated, a preset reference period is acquired, the calculated maintenance period is compared to the reference period, and then it is determined whether the burn-in preventing operation should be executed or not, on the basis of the comparison result.

Here, the electrophoretic display device 100 using the third driving method includes a temperature history storing unit which stores the temperature history of the ambient temperature. For example, the temperature history storing unit stores a plurality of temperature information obtained in the previous temperature detecting steps ST11 by several times in the memory 71, or the temperature history storing unit stores the plurality of temperature data during a predetermined period in the memory 71.

In the maintenance period determining step ST16, the control circuit 70 sequentially reads the temperature history (temperature information) stored in the memory 71, compares the read temperature information to the reference temperature, and calculates the period during which the ambient temperature equal to or higher than the reference temperature is maintained.

For example, when the temperature history of the ambient temperature of every t time is maintained in the memory 71, the control circuit 70 sequentially compares the ambient temperature to the reference temperature from the latest temperature history and counts count c of the temperature history until the ambient temperature is lower than the reference temperature. The maintenance period can be acquired by the product c·t (time) of the count c and the interval t (time) of the temperature history.

The configuration for acquiring the maintenance period is not limited to the configuration in which the temperature history is stored in every time in the memory 71. For example, the period during which the ambient temperature is equal to or higher than the reference temperature may be calculated by software. Alternatively, the maintenance period may be measured by the timer 72.

Subsequently, the control circuit 70 reads the reference period stored in the memory 71. The reference period can be determined such that the burn-in is expected to occur if the ambient temperature equal to or higher than the reference temperature is maintained for a period longer than the reference period. The reference period is preset together with the reference temperature in the memory 71. Specifically, the reference period can be set as follows with reference to the experimental results shown in FIGS. 5 and 6.

In FIGS. 5 and 6, when the reflectance of a portion of the electrophoretic display device is reduced by 2% from the initial value, difference in a brightness between the portion and an area where the initial reflectance ratio is maintained can be recognized as the burn-in with. After about 20 hours elapse under the environment of 60° C. or after about 10 hours elapse under the environment of 85° C., the deterioration (reduction) ratio of the reflectance is 2%, thereby causing visible burn-in.

Accordingly, it is preferable that the reference temperature and the reference period are set on the basis of the condition that this burn-in occurs. For example, the reference temperature may be set to 60° C. and the reference period is set to 20 hours. Alternatively, the reference temperature may be set to 85° C. and the reference period is set to 10 hours.

In order to prevent the burn-in more reliably under both the condition that held at 85° C. for 10 hours and held at 60° C. for 20 hours, it is desirable that the reference temperature may be set to 60° C. and the reference period is set to 10 hours.

When 10 hours or more elapse at a temperature higher than a general ambient temperature (normal temperature), there is a possibility that the burn-in is viewed. Therefore, the reference temperature may be set to a value in the range from 20° C. to 25° C., like the first embodiment, and the reference period may be set to 10 hours. In this way, it is possible to prevent the burn-in more reliably.

The reference temperature and the reference period are not limited to the above examples. It is desirable that the reference temperature and the reference period are appropriately modified in accordance with the characteristics of the electrophoretic element 32 and the temperature of the supposed use environment.

In the above description, the reference temperature is read from the memory 71 after the maintenance period is acquired. However, the order of the operation of acquiring the maintenance period and the operation of reading the reference temperature may be changed. Alternatively, these operations may be executed simultaneously.

Subsequently, the control circuit 70 compares the maintenance period acquired in each step to the reference period read from the memory 71. When the maintenance period is equal to or longer than the reference period, the process proceeds to the particle agitating step ST13. Alternatively, when the maintenance period is shorter than the reference period, the burn-in preventing step ST30 is terminated (end).

When the particle agitating step ST13 is selected, the same particle agitating step ST13 as that of the first driving method is executed and each pulse shown in FIGS. 8A to 8D is input. In this way, by executing the operation of agitating the electrophoretic particles, it is possible to prevent the burn-in from occurring.

According to the third driving method described above in detail, the burn-in preventing step ST30 is executed on the basis of the ambient temperature and the maintenance period. Accordingly, it is possible to prevent the burn-in more reliably, compared to the driving method of executing the burn-in preventing operation on the basis of only the ambient temperature. Moreover, by taking the maintenance period into consideration, the execution interval of the burn-in preventing step ST30 is longer, compared to the first driving method. Accordingly, it is possible to reduce the power consumption.

In the third driving method, it is desirable that the agitation intensity setting step ST14 of the second driving method is executed. Accordingly, since the particle agitating step ST13 can executed with an appropriate intensity depending on the ambient temperature, the driving method capable of preventing the burn-in reliably can be realized without dependence on the ambient temperature.

In the third driving method, the agitation intensity may be set on the basis of the maintenance period acquired in the maintenance period determining step ST16, when the agitation intensity of the electrophoretic particles is set in the particle agitating step ST13. That is, the driving method may be realized such that the agitation intensity depends on the length of the maintenance period.

By executing this driving method, the particle agitating step ST13 can be executed with an optimized intensity depending on the maintenance period at the high temperature. Accordingly, it is possible to realize the driving method capable of preventing the burn-in reliably without dependence on the length of the maintenance period.

In the foregoing description, the ambient temperature and the reference temperature are simply compared to each other in the ambient temperature determining step ST15. However, instead of the ambient temperature determining step ST15, a process similar to the variation determining step ST12 of the first driving method may be executed. That is, the driving method may be realized by determining the subsequent operations on the basis of the variation of the ambient temperature from the preset reference temperature. For example, the particle agitating step ST13 may be executed, when the reference period (for example, 10 hours) is maintained at the ambient temperature higher than the preset reference temperature by 35° C.

When the variation is used as the determination reference in the third driving method, the operation is determined in consideration of the maintenance period at the high temperature in the maintenance period determining step ST16. Therefore, a setting value different from the setting value of the variation in the first driving method may be used. Of course, it is desirable that the setting value of the variation is changed depending on the characteristics of the electrophoretic element 32 (electrophoretic sheet) used.

The burn-in preventing step ST30 of the third driving method can also be executed independently of the image display operation, like the burn-in preventing step ST10 of the first driving method.

### Fourth Driving Method

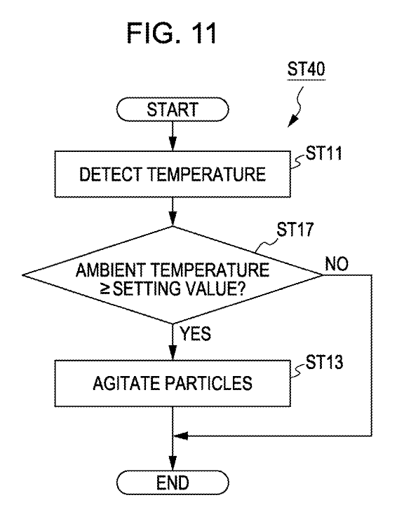

FIG. 11 is a flowchart illustrating a fourth driving method of driving the electrophoretic display device.

In the first and second driving methods, the execution of the burn-in preventing operation is determined on the basis of the variation of the ambient temperature. By determining the execution of the burn-in preventing operation on the basis of the variation, the burn-in preventing operation can be executed independently of the ambient temperature at which the electrophoretic display device operates normally for a long time. On the other hand, when a normal use ambient temperature is known in advance, it is more convenient to execute the burn-in preventing operation on the basis of the ambient temperature. In the fourth driving method, the burn-in preventing operation is executed when the ambient temperature of the electrophoretic display device 100 is set to a value equal to or higher than a setting value.

As shown in FIG. 11, the fourth driving method includes a burn-in preventing step ST40 including the temperature detecting step ST11, the ambient temperature determining step ST17, and the particle agitating step ST13.

In the ambient temperature determining step ST17, the reference temperature stored in the memory 71 is first read by the control circuit 70. Unlike the first driving method, the reference temperature stored in the memory 71 is the temperature at which the burn-in may occur when the maintenance period is long. For example, in the electrophoretic element 32 used in the experiment show in FIGS. 5 and 6, it is known that the burn-in occurs when the electrophoretic element is held at a high temperature equal to or higher than 60° C. for a long time. In such an electrophoretic element 32, the reference temperature is set to 60° C.

It is desirable that the reference temperature is set to a value in the range from 30° C. to 85° C. in consideration of the characteristics of the electrophoretic element 32 and the normal use ambient temperature. In other words, it is desirable that the burn-in preventing operation is executed when the variation from the normal use ambient temperature is between 30° C. to 40° C. Moreover, when the normal use ambient temperature is not clear, the first driving method is used.

Next, the control circuit 70 compares the current ambient temperature and the read reference temperature. When the ambient temperature is equal to or higher than the reference temperature, the process proceeds to the particle agitating step ST13. Alternatively, when the ambient temperature is lower than the reference temperature, the burn-in preventing step ST40 is terminated (end).

When the particle agitating step ST13 is selected, the same particle agitating step ST13 as that of the first driving method is executed and each pulse shown in FIGS. 8A to 8D is input. In this way, by executing the operation of agitating the electrophoretic particles, it is possible to prevent the burn-in from occurring.

According to the fourth driving method described above in detail, the burn-in preventing step ST40 is executed on the basis of the preset ambient temperature. Accordingly, since the operation of the control circuit 70 can be simplified, it is possible to reduce the power consumption and realize the electrophoretic display device 100 at lower cost.

In the fourth driving method, it is desirable that the agitation intensity setting step ST14 of the second driving method is executed. Accordingly, since the particle agitating step ST13 can executed with an appropriate intensity depending on the ambient temperature, the driving method capable of preventing the burn-in reliably can be realized without dependence on the ambient temperature.

The burn-in preventing step ST40 of the fourth driving method can also be executed independently of or in cooperation with the image display operation, like the burn-in preventing step ST10 of the first driving method.

### Electronic Apparatuses

Next, a case where the electrophoretic display device 100 is applied to an electronic apparatus will be described.

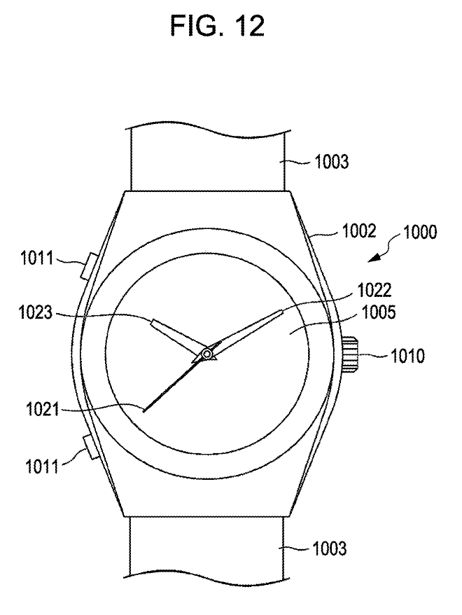

FIG. 12 is a front view illustrating a wrist watch 1000. The wrist watch 1000 includes a watch case 1002 and a pair of bands 1003 connected to the watch case 1002.

A display unit 1005 formed of the electrophoretic display device 100 according to the above-described embodiment, a second hand 1021, a minute hand 1022, and an hour hand 1023 are installed on the front of the watch case 1002. A winder 1010 serving as an operator and operational buttons 1011 are installed on the side of the watch case 1002. The winder 1010 is connected to a winding brass (not shown) installed inside the case so as to be integrated with the winding brass and is installed so as to be pressed at multi steps (for example, two steps) and so as to be rotatable. A background image, a character line such as a date or a time, a second hand, a minute hand, an hour hand, and the like can be displayed on the display unit 1005.

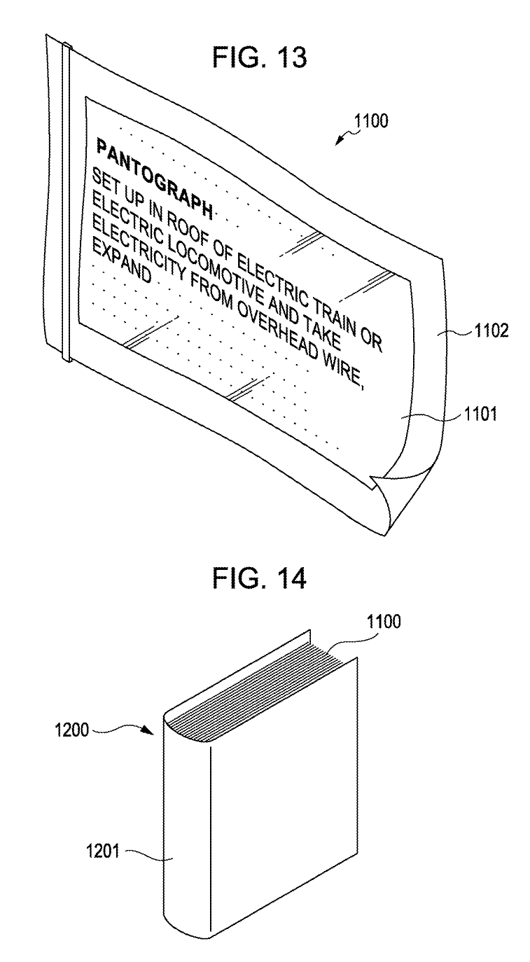

FIG. 13 is a perspective view illustrating the configuration of an electronic paper 1100. The electronic paper 1100 includes the electrophoretic display device 100 according to the above-described embodiment in a display area 1101. The electronic paper 1100 is flexible and includes a main body 1102 formed of a rewritable sheet having texture and flexibility like known paper.

FIG. 14 is a perspective view illustrating the configuration of an electronic note 1200. The electronic note 1200 is made by binding plural sheets of electronic paper 1100 and attaching a cover 1201. The cover 1201 includes a display data inputting unit (not shown) which inputs display data transmitted from an external apparatus, for example. Therefore, display details can be changed or updated in accordance with the display data with the electronic paper bound.

Since the electrophoretic display device 100 according to the invention is used in the wrist watch 1000, the electronic paper 1100, and the electronic note 1200, the electronic apparatuses including the display device capable of maintaining a display quality for a long time and being excellent in reliability can be realized.

The electronic apparatuses are just examples according to the invention and do not limit the technical scope of the invention. For example, the electrophoretic display device according to the invention is also applicable to a display device of an electronic apparatus such as a portable telephone or a portable audio apparatus.

The entire disclosure of Japanese Patent Application No. 2009-14496, filed Jan. 26, 2009 is expressly incorporated by reference herein.

What is claimed is:

1. A method of driving an electrophoretic display device including an electrophoretic element which contains electrophoretic particles and is interposed between a first substrate and a second substrate, a first electrode which is disposed between the first substrate and the electrophoretic element, and a second electrode which is disposed between the second substrate and the electrophoretic element, the method comprising:
detecting ambient temperature every predetermined period, and
agitating the electrophoretic particles by applying a voltage to the electrophoretic element on the basis of at least one of a variation of the ambient temperature from a predetermined reference temperature and a maintenance period of the ambient temperature equal to or higher than a predetermined value.

2. The method according to claim 1, wherein the agitating of the electrophoretic particles is executed when the ambient temperature is increased by 35° C. or more from the reference temperature.

3. The method according to claim 1, wherein in the agitating of the electrophoretic particles, a degree of agitation of the electrophoretic particles depends on the variation.

4. The method according to claim 1, wherein the agitating of the electrophoretic particles is executed when the maintenance period is 10 hours or more at the ambient temperature higher than the reference temperature.

5. The method according to claim 1, wherein in the agitating of the electrophoretic particles, a degree of agitation of the electrophoretic particles depends on the maintenance period.

6. The method according to claim 1, wherein the reference temperature is an average value of the ambient temperatures during a predetermined period.

7. A method of driving an electrophoretic display device including an electrophoretic element which contains electrophoretic particles and is interposed between a first substrate and a second substrate, a first electrode which is disposed between the first substrate and the electrophoretic element, and a second electrode which is disposed between the second substrate and the electrophoretic element, the method comprising:
detecting ambient temperature every predetermined period, and
agitating the electrophoretic particles by applying a voltage to the electrophoretic element when the ambient temperature is 60° C. or more.

8. The method according to claim 1, wherein in the agitating of the electrophoretic particles, a degree of agitation of the electrophoretic particles is set on the basis of a current ambient temperature.

9. The method according to claim 1, wherein in the agitating of the electrophoretic particles, a degree of agitation of the electrophoretic particles is adjusted by varying a voltage which is applied to the electrophoretic element.

10. The method according to claim 1, wherein in the agitating of the electrophoretic particles, a degree of agitation of the electrophoretic particles is adjusted by varying at least one of the pulse width and the pulse number of a voltage pulse which is supplied to the electrophoretic element.

11. The method according to claim 1, wherein in the agitating of the electrophoretic particles, the agitating of the electrophoretic particles is repeatedly executed every predetermined period.

12. The method according to claim 11, wherein in the agitating of the electrophoretic particles, a degree of agitation of the electrophoretic particles is adjusted by varying an interval at which the agitating is executed.

13. An electrophoretic display device comprising:
an electrophoretic element which contains electrophoretic particles and is interposed between a first substrate and a second substrate;
a first electrode which is disposed between the first substrate and the electrophoretic element;
a second electrode which is disposed between the second substrate and the electrophoretic element;
a temperature detector which detects ambient temperature; and
a control unit connected to the temperature detector, the control unit detecting the ambient temperature every predetermined period by means of the temperature detector and executing agitation of the electrophoretic particles by applying a voltage to the electrophoretic element, by means of the first electrode and the second electrode, on the basis of at least one of a variation of the ambient temperature from a predetermined reference temperature and a maintenance period of the ambient temperature equal to or higher than a predetermined value.

14. An electrophoretic display device according to claim 13, wherein the control unit executes the agitation of the electrophoretic particles when the ambient temperature is 60° C. or more.

15. An electronic apparatus comprising the electrophoretic display device according to claim 13.
